(19) United States
(12) Patent Application Publication
(10) Pub. No.: US 2022/0399690 A1
(43) Pub. Date: Dec. 15, 2022

(54) METHOD FOR PRODUCING AN ELECTRICAL CONNECTION ARRANGEMENT, AND ELECTRICAL CONNECTION ARRANGEMENT

(71) Applicant: Phoenix Contact GmbH & Co. KG, Blomberg (DE)

(72) Inventors: Stefan Galla, Altenbeken (DE); Philipp Peitz, Paderborn (DE)

(21) Appl. No.: 17/778,445

(22) PCT Filed: Nov. 17, 2020
(86) PCT No.: PCT/EP2020/082338

§ 371 Date: May 20, 2022

(30) Foreign Application Priority Data
Nov. 25, 2019 (BE) BE2019/5829

(51) Int. Cl. H01R 43/02; H01R 43/16

(52) U.S. Cl. CPC H01R 43/0207; H01R 43/16

(57) ABSTRACT

A method for producing an electrical connection arrangement includes: providing an electrical connection device having a base body that has a recess for accommodating a marking label; providing the marking label; inserting the marking label into the recess; and establishing an integrally-bonded and/or form-fitting connection between the marking label and the base body by ultrasonic welding.

### CROSS-REFERENCE TO PRIOR APPLICATIONS

This application is a U.S. National Phase application under 35 U.S.C. § 371 of International Application No. PCT/EP2020/082338, filed on Nov. 17, 2020, and claims benefit to Belgian Patent Application No. BE2019/5829, filed on Nov. 25, 2019. The International Application was published in German on Jun. 3, 2021 as WO/2021/104928 A1 under PCT Article 21(2).

### FIELD

The present invention relates to a method for producing an electrical connection arrangement, and an electrical connection arrangement.

### BACKGROUND

In control cabinet construction, marking labels are used to indicate, for example, the terminals of connecting terminals, terminal blocks, plug connectors and the like, hereafter generally referred to as connection arrangements. The marking labels are, for example, directly attached to the connection arrangements, such as terminal blocks. For this purpose, the marking labels usually have a clamping geometry in order to be accommodated in a form-fitting or force-fitting manner in an associated recess of a connection arrangement.

It has been shown that the known clamping connections have only limited suitability for automated production. It is thus possible for marking labels to be able to detach or slip due to vibrations, shocks, or other dynamic influences during the automated handling of, for example, a terminal block. Therefore, if inscribed marking labels have been mounted on a terminal block, marking labels can be missing or arranged in an incorrect position. If uninscribed marking labels have been mounted on a terminal block which is subsequently to be labeled automatically, the automated inscription cannot be carried out, because signs are missing or have slipped, or the automated inscription is performed incorrectly.

### SUMMARY

In an embodiment, the present invention provides a method for producing an electrical connection arrangement, comprising: providing an electrical connection device comprising a base body that has a recess configured to accommodate a marking label; providing the marking label; inserting the marking label into the recess; and establishing an integrally-bonded and/or form-fitting connection between the marking label and the base body by ultrasonic welding.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1A shows an electrical connection arrangement and a sonotrode prior to the ultrasonic welding, in a perspectival view from above;

FIG. 1B shows the electrical connection arrangement and the sonotrode from FIG. 1A during the ultrasonic welding, in a cross-section;

FIG. 2A shows a further electrical connection arrangement and a sonotrode prior to the ultrasonic welding, in a perspectival view from above; and

FIG. 2B shows the electrical connection arrangement of FIG. 2A during ultrasonic welding, in a perspectival view from above.

### DETAILED DESCRIPTION

In an embodiment, the present invention provides a method for producing an electrical connection arrangement, and an electrical connection arrangement, which facilitate reliable automated production.

The method for producing an electrical connection arrangement according to the invention is characterized by the following method steps: providing an electrical connection device, such as a terminal block or the like, wherein the electrical connection device has a base body which has a recess for accommodating a marking label; providing a marking label; inserting the marking label into the recess; producing an integrally-bonded and/or form-fitting connection between the marking label and the base body by means of ultrasonic welding.

With the use of the integrally-bonded and/or form-fitting connection by means of ultrasonic welding, a reliable fixing of the marking label on the base body can be achieved, which is also not detached by transport-related vibrations or shocks during automated handling. Thus, for example, a terminal block can be provided with one or more marking labels, which, within the context of automated control cabinet production, are initially mounted and subsequently labeled, without the risk of a marking label or several marking labels being lost.

Ultrasonic welding takes place in particular such that the base body is fixed in a support, and a sonotrode for sound transmission is placed on the marking label mounted on the base body. The required vibration energy is introduced into the marking label via the sonotrode and transmitted into the contact region or the contact regions between the marking label and the base body. In the contact region or the contact regions, the energy input results in local melting and/or fusing of the material of the marking label with the material of the base body. In the case of a purely integrally-bonded connection between the base body and the marking label, the material of the marking label is melted and fused with the material of the base body. In the case of a purely form-fitting connection, a region of the material of the marking label is melted by means of the ultrasonic welding, which material can flow into one and several undercuts formed on the base body, so that an integrally-bonded connection between the marking label and the base body can be formed there.

The electrical connection device can be a connecting terminal, a terminal block, a plug connector or the like. If the connection device is a terminal block, the base body can be a so-called terminal of a terminal block which has one or more connection openings for the insertion and contacting of electrical conductors. Such a terminal can have, for example, a spring-loaded clamping mechanism and/or a screw connection in order to clamp a conductor end or several conductor ends.

It can be provided that the base body have one of the following plastics in the region of the recess: acrylonitrile butadiene styrene copolymer (ABS), polystyrene (PS), polycarbonate (PC), styrene acrylonitrile copolymers (SAN) or polymethyl methacrylate (PMMA), such as polypropylene (PP), polyamide (PA), polyimide (PI) polyoxymethylene (POM) or polyethylene (PE), polyarylsulfones (PSU, PPSU), polyetheretherketone (PEEK), polyester (PES), polyethylene terephthalate (PET), silicone.

It can be provided that the marking label have one of the following plastics or consist of one of the following plastics: acrylonitrile butadiene styrene copolymer (ABS), polystyrene (PS), polycarbonate (PC), styrene acrylonitrile copolymers (SAN) or polymethyl methacrylate (PMMA), such as polypropylene (PP), polyamide (PA), polyimide (PI) polyoxymethylene (POM) or polyethylene (PE), polyarylsulfones (PSU, PPSU), polyetheretherketone (PEEK), polyester (PES), polyethylene terephthalate (PET), silicone.

The plastics of the marking label and of the base body are selected in such a way that they can be welded together by ultrasonic welding or can be melted at least in subregions. In order to be able to achieve good weldability or meltability, the plastic of the marking label and the plastic of the base body are preferably selected such that they have a similar melting point—in particular, the same melting point.

For example, it can be provided that amorphous plastics be welded together by ultrasonic welding.

Alternatively, it can be provided that semi-crystalline plastics be welded together by ultrasonic welding.

Alternatively, it can be provided that semi-crystalline plastics and amorphous plastics be welded together.

For example, it can be provided that the base body have a polyamide or consist of a polyamide in the region of the recess.

For example, it can be provided that the marking label have a polyamide or can consist of a polyamide.

Furthermore, it is possible for the base body to have a polycarbonate or consist of a polycarbonate in the region of the recess.

Furthermore, it is further possible that the marking label have a polycarbonate or can consist of a polycarbonate.

After the ultrasonic welding, the marking label can be laser inscribed. Laser inscription can be carried out using a UV laser or CO2 laser. In this way, a cost-effective and robust method for attaching and inscribing the marking labels on the electrical connection device can be specified, wherein the method is suitable for automation and mass production due to the reliable connection between the marking label and the base body.

In particular, it can be provided that the plastic of the marking label be suitable for both ultrasonic welding and laser inscription.

It can be provided that the marking label be inscribed prior to the ultrasonic welding. An already-inscribed label can thus be connected to the base body.

According to further embodiments, it can be provided that, instead of the laser inscription, alternative inscription or marking methods be used, such as inkjet printing, pad printing, or the like.

Provision can be made for the electrical connection device of the electrical connection arrangement to be a terminal block, which, together with the marking label used, is pre-mounted on a support rail for a control cabinet before the marking label is inscribed. Accordingly, the electrical connection device can be mounted on a support rail prior to the inscribing of the marking label.

Furthermore, it can preferably be provided that the marking label have an inscription portion and a clamping portion, wherein the clamping portion can have two projecting webs, and wherein, during the ultrasonic welding, the webs abut against the base body and can be welded to the base body, and/or the inscription portion can abut against the base body and can be welded to the base body.

In particular, it can be provided that the inscription portion have a side to be inscribed or an inscription surface which can be spaced apart from the projecting webs and/or from welded connections formed between the marking label and the base body. It can thereby be achieved that the area available for inscription not be reduced by the welded connection provided.

To pre-fix the marking label on the base body, it can be provided that the marking label be connected to the base body in a form-fitting and/or force-fitting manner prior to the ultrasonic welding. In particular, it can be provided that projecting webs of the marking label engage in undercuts or latching grooves of the recess and/or be braced in the recess in order to connect the marking label to the base body in a form-fitting and/or force-fitting manner. Accordingly, in addition to the ultrasonic welding, the marking label can additionally be connected to the base body in a form-fitting and/or force-fitting manner.

According to an alternative embodiment, it can be provided that the marking label not have a clamping portion with webs or the like, so that no form-fitting or force-fitting connection is formed in the region of the recess. In particular, it can be provided that a planar contact be formed between the marking label and the recess, so that the marking label and the base body are connected to one another exclusively in an integrally-bonded manner by means of ultrasonic welding. For example, it can be provided that a rear side of the inscription portion facing away from an inscription surface be welded to the base body. Alternatively or additionally, it can be provided that a welding section adjoining the inscription section be welded in a region of the recess, wherein the welding section does not engage in an undercut and, viewed along an assembly direction along which the marking label is inserted into the recess, does not form an integrally-bonded connection with the marking label.

In particular, it is provided that no bonding of the marking label to the base body be effected by means of an adhesive. Accordingly, an additional adhesive is preferably dispensed with entirely.

In particular, in the case of ultrasonic welding, a homogeneous fusing of adjoining plastics of the marking label and of the base body takes place.

The strength of a welded connection formed between the marking label and the base body can be adjusted by the welding parameters of the ultrasonic welding. For example, the strength of a welded connection can be adjusted in such a way that the integrally-bonded connection between the marking label and the base body can be mechanically broken without tools, in order to facilitate the replacement of a marking label. Alternatively, the strength of a welded connection can be adjusted in such a way that the integrally-bonded connection between the marking label and the base body can be mechanically broken by means of a tool, such as, for example, a screwdriver or the like, in order to facilitate the replacement of a marking label.

It can be provided that a single marking label be inserted into a recess of a base body and be connected to the base body by ultrasonic welding in the manner described above.

Furthermore, it can be provided that a plurality of marking labels be provided and inserted into several recesses, wherein the recesses can be formed on several base bodies, and simultaneous ultrasonic welding of the respective marking labels with a respectively associated base body can take place.

For example, it can be provided that a terminal block be provided with up to 50 base bodies or up to 50 terminals, wherein each of these base bodies can have a recess for accommodating a marking label. Each of these recesses is equipped with a marking label, wherein the marking labels can be provided individually or concatenated or in a composite, and can be inserted into the recesses.

Then, a sonotrode is provided and placed onto the marking labels, so that each of the marking labels abuts against the sonotrode. In this way, the required energy input into the region of the contact points between the respective marking labels and the respectively associated base bodies can take place simultaneously, so that a plurality of marking labels can be welded simultaneously with their respectively associated base bodies.

According to the invention, a method can accordingly be provided that facilitates a robust and efficient automated method for equipping a terminal block with marking labels, wherein a subsequent, automated inscription can be carried out reliably, since a loss of individual or multiple marking labels can be avoided.

The aim according to the invention is further achieved by means of an electrical connection arrangement, with an electrical connection device, wherein the electrical connection device has a base body, wherein the base body has a recess for accommodating a marking label, and wherein the base body has an opening for inserting an electrical conductor, and with a marking label, wherein the marking label is inserted into the recess, and wherein the marking label and the base body are connected to one another in an integrally-bonded and/or form-fitting manner by means of ultrasonic welding.

A cost-effective electrical connection arrangement optimized for automated assembly methods can thus be specified, wherein a loss of the marking label by means of transport-related shocks or vibrations can be reliably avoided by means of the welded connection between the marking label and the base body.

According to a further embodiment of the connection arrangement, the marking label can have an inscription portion and a clamping portion, wherein the clamping portion can have two projecting webs, and wherein the webs can be welded to the base body by ultrasonic welding, and/or the inscription portion can be welded to the base body by means of ultrasonic welding.

In particular, welded connections are arranged at a distance from an inscription surface formed on the inscription portion, so that the available inscription surface is not reduced or impaired by the welded connections provided.

In order to achieve a reliable connection between the marking label and the base body, it can be provided that the marking label according to a further embodiment of the electrical connection arrangement be connected in a form-fitting and/or force-fitting manner to the base body. For this purpose, for example, webs of the marking label can engage in provided undercuts or grooves of the recess and/or be braced in the recess—in particular, can be resiliently elastically braced.

According to a further embodiment of the electrical connection arrangement, it can be provided that a plurality of marking labels be inserted into several recesses, wherein the recesses can be formed on several base bodies, and the respective marking labels can be welded to a respectively associated base body by means of ultrasonic welding.

For example, it can be provided that the electrical connection arrangement have a terminal block with a plurality of base bodies or terminals, each equipped with associated marking labels. An electrical connection arrangement can thus have a terminal block with a plurality of marking labels which are suitable for automated inscription.

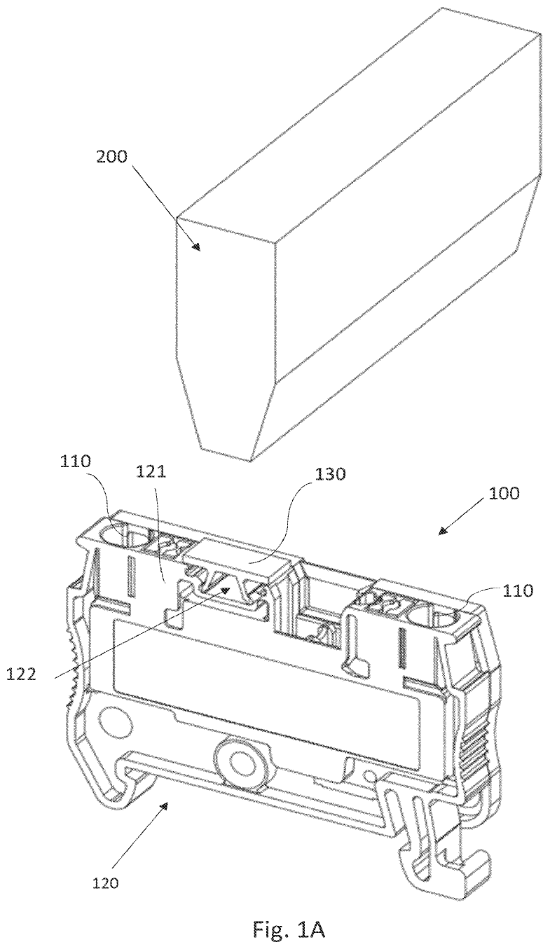

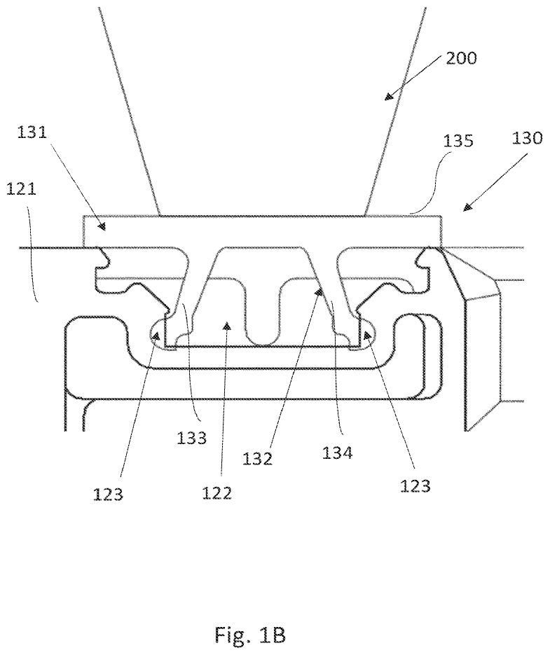

FIG. 1A shows an electrical connection arrangement 100 according to the invention. The connection arrangement 100 has openings 110 for inserting electrical conductors. The connection arrangement 100 has an electrical connection device 120 with a base body 121, wherein the base body 121 has a recess 122 for accommodating a marking label 130.

As can be seen in FIG. 1B, the marking label 130 has an inscription portion 131 and a clamping portion 132. The clamping portion 132 has projecting webs 133, 134 which engage in the recess 122.

The marking label 130 is formed here from a polyamide. The base body 121 is likewise formed from a polyamide in the region of the recess 122, from which the marking label 130 is also formed. The welded connection described below between the marking label 130 and the base body 121 is therefore homogeneous, since both the marking label 130 and the base body 121 are formed from the same material in the region of the recess.

In order to produce the electrical connection arrangement 100, the electrical connection device 120 is initially provided in a method step. The marking label 130 is inserted into the recess 122. In this state, the marking label 130 is pre-fixed in the recess 122, since the marking label 130 with its webs 133, 134 is held in a form-fitting and force-fitting manner within the recess 122.

To weld the marking label 130 to the base body 121, a sonotrode 200 of an ultrasonic welding device is lowered onto the inscription portion 131 of the marking label 130. Sound energy introduced by the sonotrode 200 into the marking label 130 leads to local melting and fusing of the marking label 130 to the base body 121, so that welded connections 123 are formed between the base body 121 and the marking label 130. In the present case, the welded connections 123 are indicated by the overlapping representation between the webs 133, 134 and the base body 121.

After the welding, the sonotrode 200 is lifted or moved away from the inscription portion 131, and an inscription surface 135 of the inscription portion 131 is labeled by laser inscription.

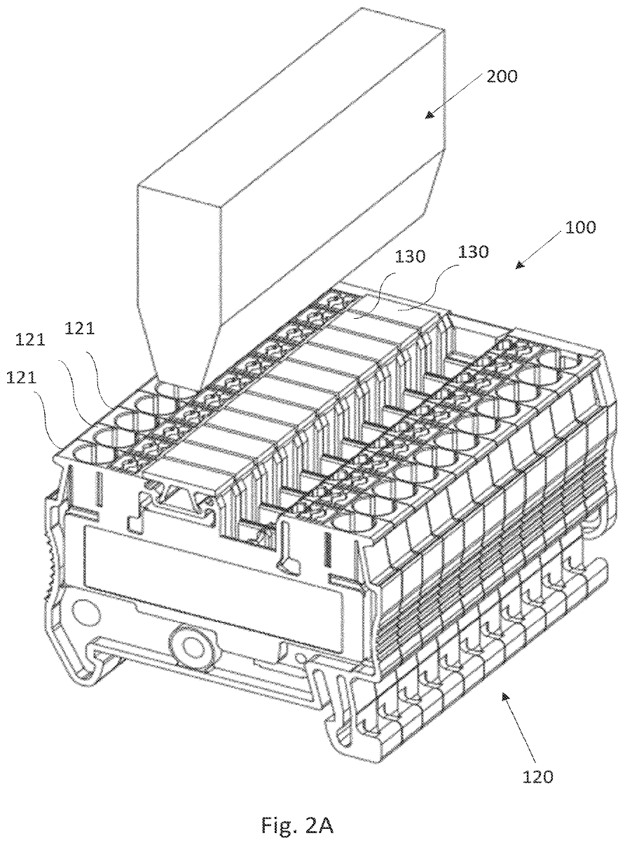

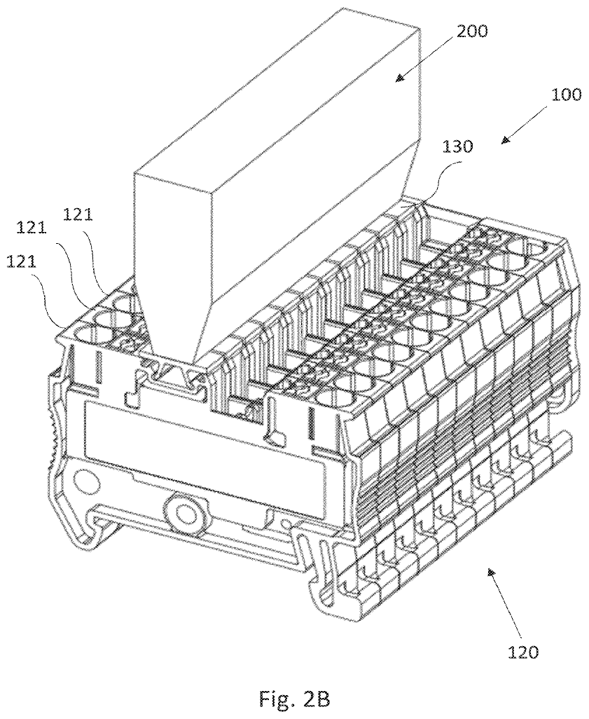

FIGS. 2A and 2B show a further electrical connection arrangement 100 according to the invention, which differs from the exemplary embodiment described above in that the electrical connection device 120 has a plurality of base bodies 121. In the present case, the base bodies 121 are terminals 121 of the connection device 120 designed as a terminal block.

A marking label 130 is arranged in each receptacle 122 of a base body 121. The sonotrode 200 covers the entire length of the marking labels 130 arranged next to one another, so that all marking labels 130 can be welded simultaneously with their respectively associated base bodies 121, as shown in FIG. 2B.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 Electrical connection arrangement
110 Opening
120 Electrical connection device/Terminal block
121 Base body/Terminal
122 Recess
123 Welded connection
130 Marking label
131 Inscription portion
132 Clamping portion
133 Web
134 Web
135 Inscription surface
200 Sonotrode

1. Method A method for producing an electrical connection arrangement, comprising:
providing an electrical connection device comprising a base body that has a recess configured to accommodate a marking label;
providing the marking label;
inserting the marking label into the recess; and
establishing an integrally-bonded and/or form-fitting connection between the marking label and the base body by ultrasonic welding.

2. The method of claim 1, wherein the base body in a region of the recess comprises a polyamide.

3. The method of claim 1, wherein the marking label comprises a polyamide.

4. The method of claim 1, wherein a laser inscription of the marking label takes place after the ultrasonic welding.

5. The method of claim 1, wherein the marking label has an inscription portion and a clamping portion,
wherein the clamping portion has two projecting webs, and
wherein, during ultrasonic welding, the webs abut the base body and are welded to the base body, and/or the inscription portion abuts the base body and is welded to the base body.

6. The method of claim 1, wherein the marking label is connected to the base body in a form-fitting and/or force-fitting manner prior to the ultrasonic welding.

7. The method of claim 1, wherein a plurality of marking labels is provided and inserted into multiple recesses, and
wherein the recesses are formed on several base bodies, and simultaneous ultrasonic welding of the respective marking labels to a respective associated base body takes place.

8. An electrical connection arrangement, comprising:
an electrical connection device comprising a base body, the base body having a recess configured to accommodate a marking label, and an opening configured for insertion of an electrical conductor, and
a marking label inserted into the recess,
wherein the marking label and the base body are connected to one another in an integrally-bonded and/or form-fitting manner by ultrasonic welding.

9. The electrical connection arrangement of claim 8, wherein the marking label has an inscription portion and a clamping portion,
wherein the clamping portion has two projecting webs, and
wherein the webs are welded to the base body by ultrasonic welding, and/or the inscription portion is welded to the base body by ultrasonic welding.

10. The electrical connection arrangement of claim 8, wherein a plurality of marking labels is inserted into several recesses, and
wherein the recesses are formed on several base bodies, and the respective marking labels are welded to a respective associated base body by ultrasonic welding.

11. The method of claim 1, wherein the electrical connection device comprises a terminal block.
